(19) United States
(12) Patent Application Publication
(10) Pub. No.: US 2003/0087636 A1
(43) Pub. Date: May 8, 2003

(54) Method for providing multi-path communication for a mobile vehicle

(75) Inventors: William E. Mazzara, Drayton Plains, MI (US); Mike A. Hichme, Rochester Hills, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation.

(21) Appl. No.: 10/040,049

(22) Filed: Nov. 7, 2001

(51) Int. Cl. H04Q 7/20

(52) U.S. Cl. 455/426; 455/522

(57) ABSTRACT

A method and system of providing multi-path communication for a mobile vehicle including at least a primary communication device. The availability of the primary communication device and a secondary communication device is determined in response to a service request. A capability of the primary communication device and the secondary communication device is determined. A service request from one of the primary communication devices and secondary communication devices is based on the capability determination. A service request is initiated from one of the primary communication devices and secondary communication devices.

### FIELD OF THE INVENTION

This invention relates generally to the communication of a mobile vehicle. In particular, this invention relates to a method for providing communication for a mobile vehicle over a multiple choice of paths.

### BACKGROUND OF THE INVENTION

A rapidly increasing segment of modern vehicles, such as passenger cars, buses, trains, boats and aircraft, are being equipped with integrated wireless communications systems. Integrated wireless communications solutions enables vehicles to have embedded systems with access to mobile services, such as navigation services, cellular phone services, emergency help/assistance, traffic information, directory assistance services, Internet web access for web browsing and email, remote car diagnostics, anti-theft tracking, in-car office, and other analog or digital voice and data communications applications.

Such embedded communications devices may have multiple communications paths to select based on various conditions, such as type of service needed (analog vs. digital), communications cost (between available service providers), changing coverage areas and service providers while a vehicle is in motion, and available wireless technology in a given area (cellular phone network-based, satellite-based, radio frequency- or RF-based, etc.). However, some integrated wireless vehicle communications solutions rely solely on the ability of the integrated communication of the embedded system to establish a communications link to a wide area network (WAN).

Recent advances in wireless technologies have lead to widespread use of portable communications devices. Examples of such devices are data capable cellular phones, bi-directional (2-way) pagers and wireless portable data assistants (PDA). Such portable wireless devices could provide a supplementary wireless communications link between the vehicle and the WAN. This would be advantageous in cases where the embedded system is experiencing service interruption, or cannot provide a certain service type available to the portable device.

It would therefore be desirable to provide a method for determining the preferred communications device used to establish a communications link from the vehicle to the WAN.

### SUMMARY OF THE INVENTION

One aspect of the present invention provides a method for providing multi-path wide area network access for a mobile vehicle. The primary communication device of the vehicle integrated communications system may access a wide area network (WAN). Upon initiation to the WAN, the secondary communication device availability is determined when the primary communication device queries the service provider. The service type of the secondary communication device is determined when the primary communication device queries the system. The viable battery life of the secondary communication device is determined by the power state and power life indications. The most current received signal strength indication (RSSI) of the secondary communication device is determined when the primary communication device queries the system. If a determination is made by the primary communication device that a more reliable service is available on the secondary communication device, the pending WAN connection request is initiated by the secondary communication device. The success of the WAN connection is determined when the primary communication device queries the call state of the secondary communication device.

Another aspect of the present invention provides a system for determining a multi-path wide area network access system for a vehicle. The system may include means for making an initial connection request to a WAN, means for determining the availability of the secondary communication device, means for determining the service availability and service type of the secondary communication device, means for determining the battery life viability of the secondary communication device, means for determining the most current RSSI, means for determining reliability of the available service of the secondary communication device, and means for the secondary communication device initiating a connection request to the WAN. The system may also include means for determining the success of the WAN connection based on the call state.

Another aspect of the present invention provides a computer usable medium including a computer program code for providing multi-path wide area network access for a mobile vehicle. The computer usable medium may include computer program code that determines if a secondary communication device is available, computer program code that determines service type, computer program code that determines battery life viability, computer program code that determines most relative signal strength indication, and computer program code that determines reliability of the secondary communication device. The program code may also include computer program code that initiates a service request from the secondary communication device.

The program may also include computer program code that computes a calibrated battery life threshold for determination of viable power. The program may also include computer program code that determines the battery life threshold based on the power state and/or the power life. The program may also include computer program code that computes a calibrated RSSI threshold. The program may also include computer program code that checks for received signal strength indication once the battery life exceeds the calibrated threshold.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for communicating from a vehicle to a service provider in accordance with the present invention;

FIG. 2 is a schematic diagram of another embodiment of a system consisting of a portable network access device linked to an embedded device of a vehicle in accordance with the present invention; and

FIG. 3 is a flow diagram of one embodiment of a method for determining a multi-path wide area network access for a vehicle in accordance with the current invention.

### DETAILED DESCRIPTION OF THE PRESENTLY PREFERRED EMBODIMENTS

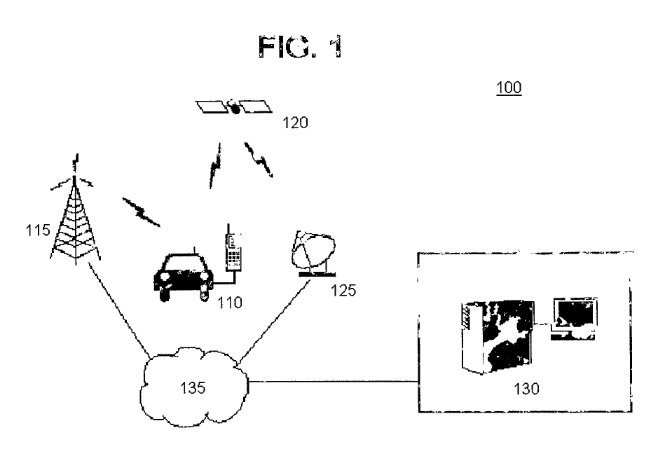

FIG. 1 shows one embodiment of a system for communicating from a vehicle to a service provider in accordance with the present invention at 100. The system 100 may include one or more vehicle clients 110, one or more carrier systems (115, 120, 125), one or more communication networks or wide area networks (WAN) 135, and one or more service providers 130.

Vehicle client 110 may be any suitable vehicle. For example, the vehicle may be an automobile or a passenger carrying unit such as a bus, train, boat or aircraft. The vehicle client 110 may be an embedded device that is capable of providing remote services to the vehicle via a wireless communication link with one or more service providers 130.

The carrier system (115, 120, 125) may be any suitable system for transmitting a signal between a vehicle and a service provider via a communications network. In one embodiment of the invention the carrier system may be a wireless carrier system 115 such as a personal communications system (PCS), a global system for mobile communication (GSM), or the like. In another embodiment of the invention, the carrier system may be a link to one or more satellites 120 that is in communication with one or more base satellite dish receivers 125. In another embodiment of the invention, the carrier system is a link to one or more satellites 120 that relays the signal between one or more other satellites 120 before communicating with one or more base satellite dish receivers 125. Other examples of carrier systems are radio links such as microwave, citizen's band (CB), dedicated radio systems such as police, military, or any other suitable radio communications link.

Communications network 135 may be any suitable system for communicating between vehicle client 110 or carrier systems (115, 120, 125) and a service provider 130. In one embodiment of the invention the communications network may be a public switched telephone network (PSTN). In another embodiment of the invention, the communications network may be a multiprotocol Internet protocol (IP) network such as Internet, extranet, private network, virtual private network (VPN), or any other wide area network (WAN) capable of carrying voice and/or digital data in either digital and/or analog format. Alternately the communications network may be a hybrid or virtual communication network.

Service provider 130 may be any remote system that can provide wireless services to the vehicle client, which may include, for example, a public telephone network. In one embodiment of the invention the service provider may provide navigation services to an embedded vehicle navigation system. In another embodiment of the invention the services provider may provide emergency assistance using a system such as OnStar. Examples of remote services delivered to the vehicle are navigation services, cellular phone services, emergency help/assistance, real-time traffic information, directory assistance services, Internet web access for web browsing and email, music and video, weather and news reporting, real-time stock market updates, remote car diagnostics, anti-theft tracking, in-car office, and other analog and/or digital voice and/or data communications applications. The service provider 130 may be a single service provider or a combination of several service providers. The service provider may be capable of serving multiple vehicle clients simultaneously.

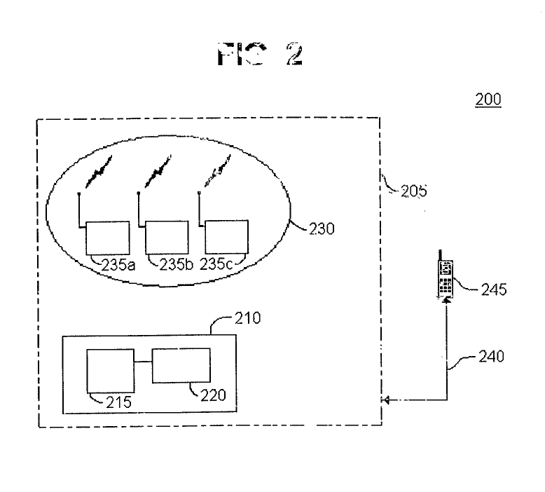

FIG. 2 shows one embodiment of a system consisting of a portable communications device (PCD) linked to an embedded device of a vehicle capable of communicating with a service provider in accordance with the present invention at 200. The system 200 may include one or more embedded devices 205, one or more embedded communication devices 230, one or more controllers 210, and one or more links 240 to one or more PCDs 245.

Embedded device 205 may be any integrated service system in the vehicle. In one embodiment of the invention the embedded device may be a system, such as OnStar, capable of providing remote services to the vehicle, such as navigation instructions, roadside assistance, emergency assistance, and directory assistance services. The embedded device 205 may include a global positioning system (GPS) receiver capable of providing vehicle positioning information to the embedded system as well as communicating it to the service provider. In another embodiment of the invention the embedded device may be a GPS based navigation system capable of providing visual and/or audio navigation and map services to the driver from the service provider. Other examples of such embedded devices include cellular phone systems, Internet web access for web browsing and email, audio/video systems such as broadcast and/or on-demand audio and video, text-to-speech news systems, anti-theft systems such as LoJack, remote car diagnostics systems, and integrated personal computer equipment. The embedded device may be a single system or an integration of multiple systems.

The portable communications device 245 may be a portable network access device (PNAD) capable of wireless communication via a carrier system over a communications network to a service provide-. In one embodiment of the invention the PNAD may be a digital and/or analog cellular telephone. In another embodiment of the invention the PNAD may be any wireless communication device including, for example, a web-enabled personal digital assistant (PDA) such as the Palm Pilot, with wireless network access capabilities or a web-enabled wireless phone. The PNAD may be any portable device capable of communicating voice, audio, video, and/or digital data in either digital and/or analog format via a wireless carrier system over a communication network with a service provider. The PNAD may be capable of communicating with at least one embedded system via the physical and/or wireless communication link 240.

Link 240 may be any physical or wireless communication link between the PNAD and at the embedded system in a vehicle. The link may be capable of communicating voice, audio, and/or digital data in either digital and/or analog format between the embedded device and the PNAD. The PNAD may also be capable of communicating device status information and other control information with the embedded device. Examples of device status information of the PNAD are battery life and received signal strength indication (RSSI). In one embodiment of the invention, link 240 may be a physical cable between the PNAD and the embedded device. The cable may be a cable capable of conducting electric and/or electromagnetic signals. The cable may also be a fiber optical cable. In another embodiment of the invention, the link is a wireless communication link. The wireless communication link may communicate using radio signals and/or infra-red light, or the like.

Embedded communications device 230 may be any embedded wireless transceiver or collection of multiple transceivers such as devices 235a, 235b, and 235c that are part of the embedded system capable of wireless communication via a carrier system over a communications network to a service provider. In one embodiment of the invention, the communications device is an embedded analog and/or digital cellular telephone. In another embodiment, the communications device is a satellite communications device. In another embodiment of the invention, the communications device is a RF transceiver, such as a microwave, a citizen's band (CB) radio, a dedicated radio system for police or military communications, or any other suitable radio communications link. The embedded device may be any device that is capable of communicating voice, audio, video, and/or digital data in either digital and/or analog format via a wireless carrier system over a communications network with a service provider. The embedded communications device 230 may be a hybrid of various communications devices and/or a single device capable of establishing different types of communications links, such as over a cellular telephone network and/or over a satellite radio link.

Controller 210 may be any control module or device of an embedded service system that is capable of executing program logic for determining which communications device to use in order to establish the communications link with the service provider. In one embodiment of the invention, the controller contains a central processor unit (CPU) 215 that is capable of executing a method stored in memory 220 for determining whether the communications link with the service provider should be established by a PNAD or the embedded device. The controller may be capable of querying status information such as battery life and RSSI of any PNAD linked to the system.

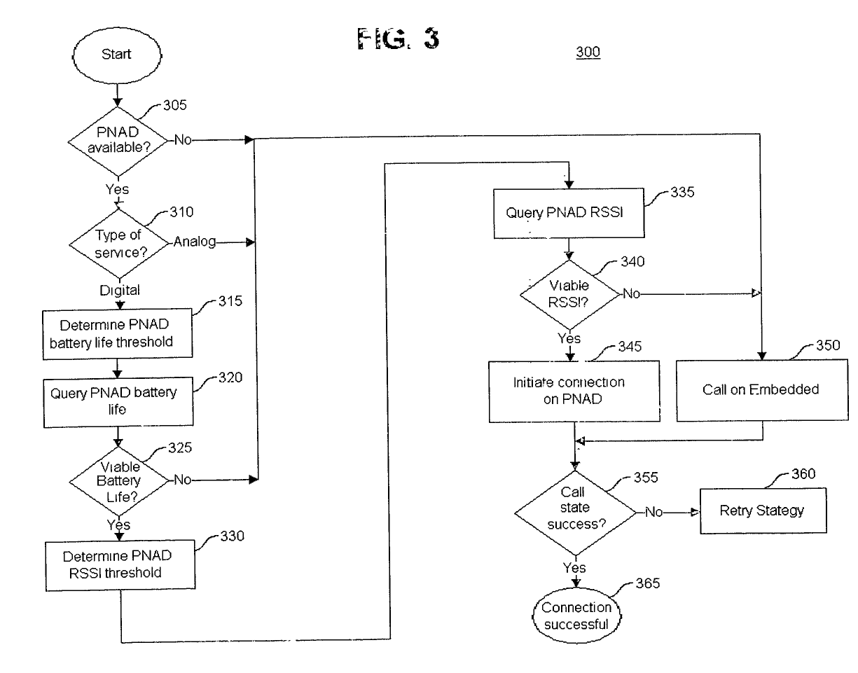

FIG. 3 shows a flow diagram of one embodiment of a method for achieving a multi-path wide area network (WAN) access to a vehicle in accordance with the present invention at 300. The method illustrated in the embodiment of 300 determines if a more reliable service is available on a portable network access device (PNAD) 245 than the service provided on the embedded device 205.

The embedded device 205 may be the system master and may handle the initiation and termination of communications sessions. The embedded device 205 may determine if more reliable service is available on the PNAD by querying the PNAD for its battery life status and its related signal strength indication (RSSI). The communications attributes of the PNAD 245 may include the type of service, the battery life, and the relative signal strength indication.

The embedded system may be capable of accessing various types of WANs, like a connection to a digital network or analog data network. Upon initiation of a WAN connection request, an embedded device 205 in a vehicle may query the system to determine if a portable network access device is available (block 305). PNAD availability may depend on one or more PNADs currently linked to the system being activated. If the PNAD is unavailable, in one embodiment, the embedded device 205 may initiate the WAN connection request (block 350).

The service type of the WAN connection may be determined prior to initiating the communications session, and may be analog cellular service, digital cellular service, or the like. For example, as new services such as satellite and packet data become available, the service type determination in block 310 may be modified to incorporate them. If the service type is determined to be analog or other non-preferred technology, the embedded communication device may initiate the WAN connection request (block 350).

When the service type is determined to be digital or the preferred technology (block 310), required battery life threshold of the PNAD 245, which provides the service chosen in 310, may be determined (block 315). The battery life threshold may be determined on parameters such as the power state and power life of the PNAD's power source, as well as the type and duration of the WAN connection. In block 320, the PNAD may be queried for its battery life state. If the battery life state of the PNAD is determined to be insufficient (block 325), the connection may be initiated by the embedded device (block 350).

If the battery life of the PNAD is determined to be sufficient, (block 325), the required received signal strength indication (RSSI) threshold of the PNAD may be determined (block 330). The PNAD may be then queried for its most current RSSI (block 335). If the most current RSSI does not exceed the required RSSI threshold for the WAN connection (block 340), the embedded device may initiate the WAN connection request (block 350). If the most current RSSI of the PNAD is determined to be sufficient (block 340), the PNAD may initiate the WAN connection request (block 345).

If the WAN connection was initiated by the PNAD (block 345), the PNAD may be queried (block 355) to determine if the WAN connection was successfully established. If the call state is determined to be unsuccessful by the PNAD (block 355), the embedded device may execute a retry strategy to establish the connection, (block 360). The retry strategy may include trying to re-establish the connection on the PNAD, or it may include initiating the request on the embedded device if the service type is available on the embedded device.

If the WAN connection was initiated by the embedded device (block 350), the system may determine if the WAN connection was successfully established. If the call state is determined to be unsuccessful (block 355), the embedded device may execute a retry strategy to establish the connection, (block 360). The retry strategy may include trying to re-establish the connection on the embedded device, or it may include initiating the request on the PNAD if the service type is available on the embedded device.

If a successful WAN connection was established by the PNAD, (block 355), both data and/or voice may be communicated via the PNAD which may then communicate with the embedded device via a two-way communications link. If a successful WAN connection was established by the embedded device (block 355), both data and/or voice may be communicated via the embedded communication device.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for providing multi-path communication for a mobile vehicle comprising:
receiving a service request;
determining availability of at least one primary communication device and at least one secondary communication device in response to the service request;
determining capability of the primary communication device and the secondary communication device; and
requesting communication from one of the primary communication device and the secondary communication device based on the capability determination.

2. The method of claim 1, further comprising:
initiating a service request from one of the primary communication device and the secondary communication device.

3. The method of claim 1, wherein the capability determination is based on factors selected from the group consisting of battery life viability, relative signal strength indication, service availability, type of service and call state.

4. The method of claim 3, wherein the battery life viability is based on a power state and a power life.

5. The method of claim 3, further comprising:
determining a calibrated threshold for the battery life viability.

6. The method of claim 5, further comprising:
determining the battery life viability if the calibrated threshold is exceeded.

7. The method of claim 3, further comprising:
determining a calibrated threshold for the received signal strength indication.

8. The method of claim 7, further comprising:
determining the received signal strength indication if the calibrated threshold is exceeded.

9. The method of claim 3, wherein the type of service is analog communication, digital communication, satellite communication, and global system for mobile communication.

10. A system for providing multi-path communication for a mobile vehicle comprising:
means for receiving a service request;
means for determining availability of at least one primary communication device and at least one secondary communication device in response to the service request;
means for determining capability of the primary communication device and the secondary communication device; and
means for requesting communication from one of the primary communication device and the secondary communication device based on the capability determination.

11. The system of claim 10, further comprising:
means for initiating a service request from one of the primary communication device and the secondary communication device.

12. The system of claim 10, further comprising:
means for determining a calibrated threshold for the battery life viability.

13. The system of claim 12, further comprising:
means for determining the battery life viability if the calibrated threshold is exceeded.

14. The system of claim 10, further comprising:
means for determining a calibrated threshold for the relative signal strength indication.

15. The system of claim 14, further comprising:
means for determining the relative signal strength indication if the calibrated threshold is exceeded.

16. A computer usable medium including a program for providing multi-path communication for a mobile vehicle comprising:
computer usable code for receiving a service request;
computer usable code for determining availability of at least one primary communication device and at least one secondary communication device in response to the service request;
computer usable code for determining capability of the primary communication device and the secondary communication device; and
computer usable code for requesting communication from one of the primary communication device and the secondary communication device based on the capability determination.

17. The computer usable medium of claim 16, further comprising:
computer program code for initiating a service request from one of the primary communication device and the secondary communication device.

18. The computer usable medium of claim 16, wherein the capability determination is based on factors selected from the group consisting of battery life viability, received signal strength indication, service availability, type of service and call state.

19. The computer usable medium of claim 18, wherein the battery life viability is based on a power state and a power life.

20. The computer usable medium of claim 18, further comprising:
computer usable code for determining a calibrated threshold for the battery life viability.

21. The computer usable medium of claim 20, further comprising:
computer usable code for determining the battery life viability if the calibrated threshold is exceeded.

22. The computer usable medium of claim 18, further comprising:
computer usable code for determining a calibrated threshold for the relative signal strength indication.

23. The computer usable medium of claim 22, further comprising:
computer usable code for determining the relative signal strength indication if the calibrated threshold is exceeded.

24. The computer usable medium of claim 18, wherein the type of service is analog communication, digital communication, satellite communication, and global system for mobile communication.
